(19) United States
(12) Patent Application Publication
(10) Pub. No.: US 2004/0171722 A1
(43) Pub. Date: Sep. 2, 2004

(54) Flame retardant polyurethanes and additive compositions for use in producing them

(76) Inventors: William R. Brown, Baton Rouge, LA (US); Elbert F. Feske, Denham Springs, LA (US); Arthur G. Mack, Prairieville, LA (US)

Correspondence Address: EDGAR SPIELMAN, ALBEMARLE CORPORATION, 451 FLORIDA BLVD., BATON ROUGE, LA, 70801, US

(21) Appl. No.: 10/377,569

(22) Filed: Feb. 28, 2003

(51) Int. Cl. C09K 21/00; C08K 5/17; C08K 5/33

(52) U.S. Cl. 524/115; 252/609; 524/236

(57) ABSTRACT

Provided are liquid flame retardant additive compositions fo low viscosity for use in flexible polyurethane foams. Preferred compositions are capable of minimizing, if not eliminating, visible scorching of the foam during its production. Flexible flame retardant polyurethane foams, and methods for their production are also provided. The flame retardant additive compositions are formed at least from a) at least one brominated aromatic diester diol; b) at least one substituted triphenylphosphate in which on average at least one phenyl group has an alkyl substituent; c) at least one hindered amine antioxidant; and d) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms.

### TECHNICAL FIELD

This invention relates to novel flame retardant additive compositions for use in the production of flexible polyurethane foams, and to flame retardant flexible polyurethane foams made using such additive compositions or the components thereof in the production of such foams.

### BACKGROUND

The manufacture of flexible polyurethane foams, requires mixing components (e.g., isocyanates and polyols along with various surfactants, water, auxiliary blowing agents, catalysts, etc., depending on the foam to be produced, its density and cell structure) and causing or allowing them to react. Modem equipment or techniques involve metering components into a reaction chamber wherein they are mixed and passed onto a conveyor or in a mold where the mixture is allowed to foam. Flame retardants are metered into the reaction chamber along with the other components for mixing.

Because polyurethane foams are produced by reaction involving two main liquid components, viz., isocyanates and polyols, it is desirable for a flame retardant composition to be in the form of a liquid with low viscosity so that it will mix readily and thoroughly with the reactants at ordinary ambient temperatures.

In the manufacture of flexible foams large billets or buns of foam are produced and then set aside to cure or to complete the polymerization reaction. Temperatures within the billet from the reaction can reach 150° to 180° C. and higher. The insulating properties of the foam maintain this temperature in the interior of the billet for an extended period of time. Thus, components which are introduced into the foam, including the flame retardant components, should, if possible, be able to withstand high temperatures and not cause scorching or charring to be visible in the foam.

### THE INVENTION

In accordance with one embodiment of this invention new effective flame retardant additive compositions for use in flexible polyurethane foams are provided that are in the form of a liquid with low viscosity. In accordance with a preferred embodiment of this invention new flame retardant additive compositions for flexible polyurethane foams are provided that are in the form of a liquid with low viscosity and that are capable of minimizing, if not eliminating, visible scorching of the foam during its production. Foams exhibit little, if any, visible evidence of scorching while in the form of a billet or bun during and after the time the billet or bun is cooling down to ambient room temperature.

Other embodiments of this invention include the provision of flexible flame retardant polyurethane foams, and preferably flexible flame retardant foams that exhibit little, if any, visible evidence of scorching while in the form of a billet or bun. Processes of producing the respective flexible polyurethane foams referred to in this paragraph constitute still further embodiments of this invention.

The new liquid flame retardant additive compositions of this invention comprise a liquid mixture formed from at least the following components or ingredients:

a) at least one brominated aromatic diester diol;

b) at least one alkylated triphenylphosphate;

c) at least one hindered amine antioxidant; and

d) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms.

Typically in forming the mixture these components or ingredients are used in amounts such that on a weight basis (1) the proportions of a) to b) are in the range of about 30:70 to about 70:30; (2) the proportions of c) to d) are in the range of about 3:1 to about 1:3; and (3) the weight ratio of a) plus b) to c) plus d) is in the range of about 5:1 to about 25:1, and preferably in the range of about 7:1 to about 15:1.

Flexible polyurethane foams of this invention will typically be formed using about 2.5-10.5 parts by weight of a), about 1.5-7.5 parts by weight of b), about 0.05-0.4 part by weight of c), and about 0.05-0.4 part by weight of d) per each 100 parts by weight of polyol used in forming the polyurethane foam. Preferred flexible polyurethane foams of this invention are formed using about 4.0-8.4 parts by weight of a), about 2.4-6.0 parts by weight of b), about 0.09-0.2 part by weight of c), and about 0.09-0.2 part by weight of d) per each 100 parts by weight of polyol used in forming the polyurethane foam. Preferably, these components are used in the form of a preformed liquid flame retardant additive composition of this invention as this simplifies the blending step and minimizes the possibility of blending errors. However, if desired, components or ingredients a), b), c), and d) can be added individually and/or in one or more subcombinations to the mixture to be used in forming the polyurethane.

Departures from the above amounts and proportions whenever deemed necessary or desirable are permissible and within the scope of this invention.

The above and other embodiments and features of this invention will be still further apparent from the ensuing description.

As used herein, the term “liquid” means that the additive composition is in the liquid state of aggregation at 22° C. even if no ancillary solvent is present. Thus at least some, and preferably all of the components or ingredients of a), b), c), and d) are themselves in the liquid state of aggregation at 22° C. However, it is permissible for one or more such components or ingredients to be in the solid state of aggregation at 22° C., provided at least one such component or ingredient is in the liquid state of aggregation at 22° C. and the presence of such liquid component(s) or ingredient(s) in the composition results in the overall composition of components or ingredients of a), b), c), and d) being in the liquid state of aggregation at 22° C. Preferred liquid additive compositions of this invention have a viscosity of no more than about 1000 to 15,000 centipoise (using a Brookfield viscometer) at 25° C.

If instead of using a liquid additive composition of this invention, one or more of components or ingredients a), b), c), and d) are added to the polymerization formulation or recipe individually and/or as one or more subcombinations, it is preferred that each such individual component or ingredient and/or each subcombinations thereof be a liquid. However, one or more such components or ingredients can be in the solid state provided they can be rapidly and homogeneously mixed into the polymerization formulation or recipe. As is known in the art, a polymerization formulation or recipe apart from components or ingredients a), b), c), and d) typically comprises at least one or more of such components or ingredients as the following: polyol, isocyanate, surfactant, catalyst, and blowing agent.

As used herein, the term “alkylated triphenylphosphate” does not necessarily mean that triphenylphosphate itself is alkylated. In fact, methods used in the art to prepare products which can be used in the practice of this invention generally involve at least two different process approaches. In one approach phenol is alkylated to form ring-alkylated phenol mixtures which may contain unreacted phenol, or which may be blended with phenol so that the mixture contains some phenol. Such mixture is reacted with a phosphoryl halide (typically POCl₃). This forms a product which is a mixture of different alkyl-substituted triphenylphosphates. Some triphenylphosphate itself may be present in such product mixture. In another approach phenol is alkylated more extensively to form a mixture of different alkyl-substituted phenols. These more extensively alkylated phenols are reacted with a phosphoryl halide (typically POCl₃) to form mixture of different alkyl-substituted triphenylphosphates. Triphenylphosphate, a solid at ordinary temperatures, is then added to the mixture of different alkyl-substituted triphenylphosphates to form a liquid product mixture. In addition to mixtures, it is also possible in the practice of this invention to use individual triphenylphosphates in which:

a) only one phenyl group has an alkyl substituent, such as tolyldi(phenyl)phosphate (often called cresyldiphenylphosphate or CDP), or (isopropylphenyl)di(phenyl)phosphate, or the like; or

b) only two phenyl groups have alkyl substitution, such as phenyldi(tolyl)phosphate, or di(tert-butylphenyl)phenylphosphate, or the like; or

c) all three phenyl groups have alkyl substitution, such as tri(tolyl)phosphate, (often called tricresylphosphate or TCP), or tolyldi(ethylphenyl)phosphate, or the like.

Therefore, as used herein the term “alkylated triphenylphosphate” refers to one or more triphenylphosphates in which at least one of the phenyl groups has at least one alkyl group (CH₂ₙ₊₁) as a substituent thereon, and wherein triphenyl phosphate itself can be in admixture therewith or can be absent. Unless otherwise indicated herein, the method by which such “alkylated triphenylphosphate” is formed or prepared is of no consequence.

Component a)

Various liquid brominated aromatic diester diols can be used. Typically these compounds are liquid diol esters of a bromoaromatic 1,2-dicarboxylic acid or anhydride in which the compound has 1-4, and preferably 2-4, bromine atoms per molecule. Non-limiting examples of such liquid bromoaromatic diol esters include the reaction product of 1,4-butane diol and propylene oxide with tetrabromophthalic anhydride, the reaction product of diethylene glycol and ethylene oxide with tetrabromophthalic anhydride, the reaction product of tripropylene glycol and ethylene oxide with tribromophthalic anhydride, the reaction product of 1,3-butane diol and propylene oxide with tetrabromophthalic anhydride, the reaction product of dipropylene glycol and ethylene oxide with dibromosuccinic anhydride, the reaction product of two moles of ethylene oxide with tribromophthalic anhydride and other similar compounds.

The more preferred compounds of this type are liquid diol esters of polybromophthalic acid or anhydride, especially where the aromatic moiety has 4 bromine atoms. Examples of such more preferred compounds are SAYTEX® RB-79 flame retardant (Albemarle Corporation), and PHT4-Diol (Great Lakes Chemical Corporation). Methods for manufacturing such compounds and other examples of such compounds are described for example in U.S. Pat. No. 4,564,697 issued Jan. 14, 1986 to Burton J. Sutker and entitled “Halogenated Polyol-Ester Neutralization Agent”.

Component b)

Typically this component is one or more liquid alkylated triphenyl phosphates which contain on average at least one alkylated phenyl ester group in the molecule. A product available from Ciba Specialty Chemicals, Inc. as PLIABRAC® 519 additive can be used for as this component. In essence it is a triaryl phosphate containing a mixture of isomers which, on the average contain one isopropyl phenyl group per molecule. However, the mixture contains some phenyl esters and polyalkylated phenyl esters. Also, the position of the isopropyl group(s) varies. The mixture can be made in accordance with the procedures set forth in U.S. Pat. No. 3,576,923 to Randell et al. A typical analysis of PLIABRAC® 519 is given in U.S. Pat. No. 5,164,417. Non-limiting examples of other liquid alkylated triphenyl phosphates include Antiblaze® 519 from Rhodia, Inc., Phosflex® 31L from Akzo Nobel N.V., Kronitex 50 from Great Lakes Chemical Corporation, and Pyrosafe® 220 Clear from Chemron Corporation, Pase Robles, Calif.

A preferred liquid alkylated triphenyl phosphate is available under the trade designation Pyrosafe® 220 Clear from Chemron Corporation. This additive is a tertiary butylated triphenyl phosphate.

U.S. Pat. No. 2,960,524 to Wilson is a patent which describes a method of making propylated (or isopropylated or 2-propylated) aryl phosphate esters which are useful in the practice of this invention. U.S. Pat. No. 4,139,487 also describes mixed triaryl (phenyl and alkylphenyl) phosphate esters which are useful for the practice of this invention.

Individual alkyl-substituted triphenylphosphates which can be used include di(phenyl)tolylphosphate, phenylditolylphosphate, di(phenyl)xylylphosphate, (ethylphenyl)di(phenyl)phosphate, (isopropylphenyl)di(phenyl)phosphate, (tert-butylphenyl)di(phenyl)phosphate, and like aromatic phosphate esters. Such individual alkyl-substituted triphenylphosphates can be used (a) in combinations of two or more thereof, or (b) in combinations of one or more thereof with triphenylphosphate.

Component c)

This component is at least one hindered amine antioxidant which preferably is a liquid. One type of liquid hindered amine antioxidant is a liquid alkylated diphenylamine in which the alkyl ring substituent or substituents each contain about 4-9 carbon atoms. One such product is Irganox® 5057 antioxidant (Ciba Specialty Chemicals, Inc.) which is a mixture N-phenylbenzeneamine (i.e., diphenylamine) reaction products with 2,4,4-trimethylpentene. A similar product is available from Great Lakes Chemical Corporation under the trade designation Durad® AX 57. Non-limiting examples of other suitable liquid hindered amine antioxidant components include Durad AX 55 (mixture of tertiary octylated and styrenated diphenylamine), and Durad AX 59 (nonylated diphenylamine). Also suitable are hindered-amine antioxidants such as 4-benzoyloxy-2,2,6,6-tetramethylpiperidine, bis(2,2,6,6-tetramethyl-4-piperidinyl)sebacate, bis(1-octyloxy-2,2,6,6-tetramethyl-4-piperidinyl)sebacate, bis(1,2,2,6,6-pentamethyl-4-piperidinyl)sebacate, dimethyl succinate-1-(2-hydroxyethyl)4-hydroxy-2,2,6,6-tetramethylpiperidine and condensed products thereof, and 8-acetyl-3-dodecyl-7,7,9,9-tetramethyl-1,3,8-triazaspyrro[4,5]decane-2,4-dione. These may be used individually or in combinations with each other, or with other hindered amine antioxidants. Use of Irganox® 5057 is preferred.

Component d)

One or more liquid phenolic antioxidants in which the phenolic ring is substituted by an alkanoic acid alkyl ester group are used as this component. The phenolic ring is preferably sterically hindered by having one or preferably each of its ortho positions substituted by an alkyl or cycloalkyl group such that the total number of carbon atoms in the ortho alkyl or cycloalkyl group(s) is at least 4 and more preferably at least 5. Desirably at least one such ortho substituent is a tertiary alkyl group, most preferably a tertiary butyl group. The alkanoic acid alkyl ester substituent group is preferably in the para position relative to the hydroxyl group, and is composed of an C₂₋₆ alkanoic acid group (preferably a propionic acid group) which is esterified with an alkyl group having in the range of about 6-16 carbon atoms. In other words, this substituent group can be depicted as —R¹COOR², where R¹ is alkylene having 1-5 carbon atoms and R² is alkyl having in the range of about 6 to about 16 carbon atoms, and preferably in the range of about 6 to about 10 carbon atoms. Mixtures of two or more such alkyl ester substituted phenolic antioxidants can be used. One example of a useful compound of this type is Irganox® 1135 antioxidant (Ciba Specialty Chemicals, Inc.) which chemically is indicated by the manufacturer to be an isooctyl ester of 3,5-di-tert-butyl-4-hydroxylphenylpropionic acid (or a C₇-C₉ branched alkyl ester of 3,5-bis(1,1-dimethylethyl)-4-hydroxybenzenepropionic acid). Other non-limiting examples of compounds of this type that may be used include C₇-C₉ branched alkyl ester of 3-tert-butyl-5-methyl-4-hydroxylphenylpropionic acid, C₇-C₉ branched alkyl ester of 3,5-diisopropyl-4-hydroxylphenylpropionic acid, C₆-C₈ branched alkyl ester of 3-tert-amyl-5-methyl-4-hydroxylphenylpropionic acid, C₈-C₁₀ branched alkyl ester of 3,5-di-tert-butyl-4-hydroxylphenylacetic acid, C₇-C₈ branched alkyl ester of 3-tert-butyl-5-methyl-4-hydroxylphenylbutyric acid, and C₆ branched alkyl ester of 3-tert-amyl-5-methyl-4-hydroxylphenylhexanoic acid.

Other Components of the Polymerization Formulation or Recipe

Apart from components or ingredients a), b), c), and d), other components used in forming polyurethane polymerization formulations or recipes are well known to those of ordinary skill in the art. Flexible polyurethane foams are typically prepared by chemical reaction between two liquids, isocyanates and polyols. The polyols are polyether or polyester polyols. The reaction readily occurs at room temperature in the presence of a blowing agent such as water, a volatile hydrocarbon, halocarbon, or halohydrocarbon, or mixtures of two or more such materials. Catalysts used in effecting the reaction include amine catalysts, tin-based catalysts, bismuth-based catalysts or other organometallic catalysts, and the like. Surfactants such as substituted silicone compounds are often used in order to maintain homogeneity of the cells in the polymerization system. Hindered phenolic antioxidants, e.g., 2,6-di-tert-butyl-para-cresol and methylenebis(2,6-di-tert-butylphenol), can be used to further assist in stabilization against oxidative degradation. These and other ingredients that can be used, and the proportions and manner in which they are used are reported in the literature. See for example: Herrington and Hock, Flexible Polyurethane Foams, The Dow Chemical Company, 1991, 9.25-9.27 or Roegler, M “Slabstock Foams”; in Polyurethane Handbook; Oertel, G., Ed.;Hanser Munich, 1985, 176-177 or Woods, G. Flexible Polyurethane Foams, Chemistry and Technology; Applied Science Publishers, London, 1982, 257-260.

In the practice of this invention preferred polyols include Voranol® 3010 polyol, (The Dow Chemical Company, Midland, Mich.) and Pluracol® 1718 polyol (BASF Corporation, Mt. Olive, N.J.).

Preferred isocyanates include Mondur TD-80, Mondur PF (Bayer Corporation, Pittsburgh, Pa.) and Luprinate T80 (BASF Corporation).

Preferred surfactants include Niax® L-620 (Osi Specialties, Greenwich, Conn.) or any other of the many polyetherpolysilicone copolymers used in typical flexible polyurethane slabstock foams.

Preferred blowing agents include a combination of water and methylene chloride, Freon 11, or acetone, in a weight ratio in the range of about 1:2 to 2:1, respectively; with water and methylene chloride being the preferred combination.

Preferred catalyst systems include a combination of a blend of amine catalysts such as a blend of (i) dimethylethyl amine, triethylene diamine, and bis(dimethylaminoethyl) ether) and (ii) DABCO® 2 T-16 amine, in a weight ratio in the range of about 0.2-0.3:1, respectively; depending upon air flow and processing needs.

The following Examples are presented for purposes of illustration. Examples 3 and 6 are illustrative of the invention, and are not intended to limit the generic scope of the invention. Examples 1, 2, 4, and 5 are comparative Examples not of this invention.

### EXAMPLES 1-6

A flexible polyurethane foam formulation was prepared from Pluracol® 1718 polyol, (a 3000 molecular weight polyoxypropylene triol, BASF Corporation); toluene diisocyanate (TDI; Mondur® TD-80, Bayer Corporation, Pittsburgh, Pa.); Niax® L-620 surfactant (a silicone surfactant; OSi Specialties); a blend of amine catalysts (dimethylethyl amine, triethylene diamine, and bis(dimethylaminoethyl) ether); T-16 tin-based catalyst (60% dibutyltin dilaurate and 40% dipropylene glycol available from Air Products and Chemicals); water as blowing agent; and methyl chloride as auxiliary blowing agent. No flame retardant was used in Examples 1 and 4.

In Examples 2 and 5, a typical flame retardant tris(dichloropropyl)phosphate (FYROL® FR-2; Akzo Nobel Chemicals Inc.) was included in the formulations otherwise essentially corresponding respectively to Examples 1 and 4.

In Examples 3 and 6, a flame retardant composition of this invention was formed by including the following components or ingredients in the formulations otherwise essentially corresponding respectively to Examples 1 and 4: SAYTEX® RB-79 flame retardant (a mixed ester of tetrabromophthalic anhydride with diethylene glycol and propylene glycol; Albemarle Corporation); Pyrosafe 220 Clear flame retardant (t-butyl triphenylphosphate from Chemron Corporation, Pase Robles, Calif. 93447); Irganox® 5057 antioxidant (Ciba Specialty Chemicals, Inc.) and Irganox® 1135 antioxidant (Ciba Specialty Chemicals, Inc.).

After polymerization, samples of the respective foams were subjected to Section A of the California 117 test procedure, and the Microwave scorch test in which a scorch index is assigned to each sample using the following designations: 0=no discoloration; 1=just discernable discoloration; 2=light yellow coloration; 3=medium yellow coloration; 4=dark yellow/orange coloration; and 5=brown coloration.

The Table sets forth the proportions of the components used in each of Examples 1-6 in terms of parts per hundred parts of polyol (by weight), and summarizes the results of these tests.

| | TABLE | | | | | |
|---|---|---|---|---|---|---|
| | Example | | | | | |
| | 1 | 2 | 3 | 4 | 5 | 6 |
| Polyol | 100.00 | 100.00 | 100.00 | 100.00 | 100.00 | 100.00 |
| Surfactant | 0.80 | 0.80 | 0.80 | 0.80 | 0.80 | 0.80 |
| Amine Catalysts | 0.14 | 0.14 | 0.14 | 0.17 | 0.15 | 0.015 |
| Tin Catalyst | 0.59 | 0.59 | 0.59 | 0.44 | 0.53 | 0.53 |
| Blowing Agent, H₂O | 3.05 | 3.05 | 3.05 | 6.15 | 6.15 | 6.15 |
| Blowing Agent, MeCl | 3.90 | 4.36 | 4.36 | 5.72 | 5.72 | 5.72 |
| Toluene Diisocyanate | 40.71 | 40.71 | 40.38 | 68.56 | 68.56 | 70.53 |
| Tris(dichloropropyl)phosphate | None | 12.0 | None | None | 24.00 | None |
| Brominated Diol | None | None | 6.00 | None | None | 12.00 |
| Aromatic Phosphate | None | None | 6.00 | None | None | 8.00 |
| Hindered Amine Antioxidants | None | None | 0.38 | None | None | 0.475 |
| Phenolic Ester | None | None | 0.76 | None | None | 0.951 |
| Density, lb/ft³ | 1.8 | 1.8 | 1.8 | 1.1 | 1.1 | 1.1 |
| Cal. 117, Sec. A, char length | Totally | Totally | 3.53 in. | Totally | Totally | 5.25 in. |
| | burned | burned | | burned | burned | |
| Cal 117, Sec. A, after burn time | N/A | N/A | 0.00 | N/A | N/A | 0.00 |
| Scorch Index* | 0 | 4 | 0-1 | 0 | 2-3 | 1 |

*0 = no discoloration;
1 = just discernable discoloration;
2 = light yellow;
3 = medium yellow;
4 = dark yellow/orange;
5 = brown

Even though the embodiments hereinabove may refer to substances, components and/or ingredients in the present tense (“comprises”, “is”, etc.), the reference is to the substance, component or ingredient as it existed at the time just before it was first contacted, blended or mixed with one or more other substances, components and/or ingredients, or if formed in solution, as it would exist if not formed in solution, all in accordance with the present disclosure. It matters not that a substance, component or ingredient may have lost its original identity through a chemical reaction or transformation during the course of such contacting, blending, mixing, or in situ formation, if conducted in accordance with this disclosure.

Each and every patent or publication referred to in any portion of this specification is incorporated in toto into this disclosure by reference, as if fully set forth herein.

This invention is susceptible to considerable variation in its practice. Therefore the foregoing description is not intended to limit, and should not be construed as limiting, the invention to the particular exemplifications presented hereinabove.

That which is claimed is:

1. A liquid flame retardant additive composition which comprises a liquid mixture formed from at least the following components or ingredients:
a) at least one brominated aromatic diester diol;
b) at least one alkylated triphenylphosphate;
c) at least one hindered amine antioxidant; and
d) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms;
wherein the amounts of components or ingredients a), b), c), and d) used in forming said mixture are such that on a weight basis (1) the proportions of a) to b) are in the range of about 30:70 to about 70:30; (2) the proportions of c) to d) are in the range of about 3:1 to about 1:3; and (3) the weight ratio of a) plus b) to c) plus d) is in the range of about 5:1 to about 25:1.

2. A composition as in claim 1 wherein a) consists essentially of a mixed ester of tetrabromophthalic anhydride with diethylene glycol and propylene glycol.

3. A composition as in claim 1 wherein b) is comprised of triphenylphosphate in which at least one of the phenyl groups contains at least one isopropyl or tert-butyl group as a substituent thereon.

4. A composition as in claim 1 wherein c) consists essentially of at least one liquid alkylated diphenylamine in which the alkyl ring substituent or substituents each contain in the range of about 4-9 carbon atoms.

5. A composition as in claim 1 wherein d) consists essentially of a C₇-C₉ branched alkyl ester of 3,5-di-tert-butyl-4-hydroxylphenylpropionic acid.

6. A composition as in claim 1 wherein a) consists essentially of a mixed ester of tetrabromophthalic anhydride with diethylene glycol and propylene glycol, and wherein b) is comprised of triphenylphosphate in which at least one of the phenyl groups contains at least one isopropyl or tert-butyl group as a substituent thereon.

7. A composition as in claim 1 wherein a) consists essentially of a mixed ester of tetrabromophthalic anhydride with diethylene glycol and propylene glycol; wherein b) is comprised of triphenylphosphate in which at least one of the phenyl groups contains at least one isopropyl or tert-butyl group as a substituent thereon; wherein c) consists essentially of at least one liquid alkylated diphenylamine in which the alkyl ring substituent or substituents each contain in the range of about 4-9 carbon atoms; and wherein d) consists essentially of a C₇-C₉ branched alkyl ester of 3,5-di-tert-butyl-4-hydroxylphenylpropionic acid.

8. In a flexible polyurethane foam composition of the type formed by mixing isocyanate and polyol along with at least one surfactant, at least one blowing agent, at least one catalyst, and reacting the mixture, the improvement which comprises the inclusion in the polymerization formulation of a flame retardant amount of additive components or ingredients a), b), c), and d) of any of claims 1-7.

9. A method of producing a flexible polyurethane foam composition, which method comprises including a flame retardant amount of a composition of any of claims 1-7 in a polymerization formulation comprised of isocyanate and polyol along with at least one surfactant, at least one blowing agent, at least one catalyst, and reacting the mixture to form a flexible polyurethane foam.

10. A method of producing a flexible polyurethane foam composition of the type formed from isocyanate and polyol, which method comprises (A) including in a polymerization formulation:
a) at least one brominated aromatic diester diol;
b) at least one alkylated triphenylphosphate;
c) at least one hindered amine antioxidant; and
d) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms;
in amounts sufficient to provide flame retardancy and scorch resistance to the flexible foam being produced, and (B) reacting the resultant formulation to form a flame retardant scorch resistant flexible polyurethane foam.

11. A method as in claim 10 wherein said a), b), c), and d) are included as a preformed liquid composition in said polymerization formulation.

12. A method as in claim 10 wherein said a), b), c), and d) are included individually and/or as subcombinations of less than all of a), b), c), and d), so that taken together all of a), b), c), and d) are included in said polymerization formulation.

13. A method as in any of claims 10-12 wherein on a weight basis the proportions of a) to b) included in said polymerization formulation are in the range of about 30:70 to about 70:30; wherein on a weight basis the proportions of c) to d) included in said polymerization formulation are in the range of about 3:1 to about 1:3; and wherein the weight ratio of a) plus b) to c) plus d) included in said polymerization formulation is in the range of about 5:1 to about 25:1.

14. A method of producing a flexible polyurethane foam composition of the type formed from isocyanate and polyol, which method comprises (A) including in a polymerization formulation a flame retardant additive composition as in any of claims 2-7, and (B) reacting the resultant formulation to form a flexible polyurethane foam.

15. A flame retardant flexible polyurethane foam formed from components or ingredients comprising isocyanate, polyol, surfactant, catalyst, and blowing agent, wherein the components or ingredients used in forming said polyurethane foam are further comprised of:
a) at least one brominated aromatic diester diol;
b) at least one alkylated triphenylphosphate;
c) at least one hindered amine antioxidant; and
d) at least one phenolic antioxidant in which the phenolic ring is substituted by an alkanoic acid alkyl ester group in which alkanoic acid moiety has in the range of 2 to about 4 carbon atoms and the alkyl group has in the range of about 6 to about 16 carbon atoms;
in amounts sufficient to provide flame retardancy and scorch resistance to the flexible foam.

16. A polyurethane foam as in claim 15 wherein a) consists essentially of a mixed ester of tetrabromophthalic anhydride with diethylene glycol and propylene glycol.

17. A polyurethane foam as in claim 15 wherein b) is comprised of triphenylphosphate in which at least one of the phenyl groups contains at least one isopropyl or tert-butyl group as a substituent thereon.

18. A polyurethane foam as in claim 15 wherein c) consists essentially of at least one liquid alkylated diphenylamine in which the alkyl ring substituent or substituents each contain in the range of about 4-9 carbon atoms.

19. A polyurethane foam as in claim 15 wherein d) consists essentially of a C₇-C₉ branched alkyl ester of 3,5-di-tert-butyl-4-hydroxylphenylpropionic acid.

20. A polyurethane foam as in claim 15 wherein a) consists essentially of a mixed ester of tetrabromophthalic anhydride with diethylene glycol and propylene glycol, and wherein b) is comprised of triphenylphosphate in which at least one of the phenyl groups contains at least one isopropyl or tert-butyl group as a substituent thereon.

21. A polyurethane foam as in claim 15 wherein a) consists essentially of a mixed ester of tetrabromophthalic anhydride with diethylene glycol and propylene glycol; wherein b) is comprised of triphenylphosphate in which at least one of the phenyl groups contains at least one isopropyl or tert-butyl group as a substituent thereon; wherein c) consists essentially of at least one liquid alkylated diphenylamine in which the alkyl ring substituent or substituents each contain in the range of about 4-9 carbon atoms; and wherein d) consists essentially of a C₇-C₉ branched alkyl ester of 3,5-di-tert-butyl-4-hydroxylphenylpropionic acid.

22. A polyurethane foam as in any of claims 15-21 wherein the amounts of components or ingredients a), b), c), and d) used in forming said mixture are such that on a weight basis (1) the proportions of a) to b) are in the range of about 30:70 to about 70:30; (2) the proportions of c) to d) are in the range of about 3:1 to about 1:3; and (3) the weight ratio of a) plus b) to c) plus d) is in the range of about 5:1 to about 25:1.
